(19) United States
(12) Patent Application Publication
(10) Pub. No.: US 2006/0196104 A1
(43) Pub. Date: Sep. 7, 2006

(54) Swimming Fish Toy

(76) Inventor: Brian Lapointe, West Yarmouth, MA (US)

Correspondence Address: BRIAN LAPOINTE, 25 COTTAGE DRIVE, WEST YARMOUTH, MA, 02673, US

(21) Appl. No.: 11/306,544

(22) Filed: Dec. 31, 2005

Related U.S. Application Data
(63) Continuation-in-part of application No. 10/906,087, filed on Feb. 2, 2005, now abandoned.

(51) Int. Cl. A01K 85/00

(52) U.S. Cl. 43/42.24

(57) ABSTRACT

The proposed invention is a mechanical, battery powered, swimming fish toy, incorporating a single motor and speed reduction gear assembly. Said swimming fish toy is controlled by an embedded electronic controller, making it capable of swimming in a truly random pattern within a fluid medium, independent of any external influence.

### FIELD OF THE INVENTION

The present invention is a continuation in part of application Ser. No. 10/906,087 originally filed on Feb. 2, 2005 and relates generally to mechanical swimming fish toys, which provide adults and children alike, with many hours of visual and interactive enjoyment. Particularly this invention addresses the problems and shortcomings of the prior art, by proposing a more cost effective swimming fish toy, which is very realistic in both appearance and function. By incorporating an embedded electronic controller and simple mechanical motion switch, this invention provides a fish, which swims in a realistic random pattern and responds to changes in its surrounding fluid environment, by turning away from obstacles and swimming more quickly when chased or disturbed.

### DESCRIPTION OF THE PRIOR ART

Numerous attempts have been made at creating a mechanical fish, which provides amusement for children, by appearing to be real as it swims about in a pool or pond. Those illustrated in U.S. Pat. Nos. 1,928,418 4,687,456 4,832,650 5,931,715 and 6,537,124 fall quite short of convincing an onlooker, that the fish they are watching is real. Among the many shortcomings of these prior art examples are included: visible joints between movable body sections, unnatural motion that remains very regular despite changes in the surrounding environment, an inability to avoid obstacles or to turn when making contact with objects, and a total lack of any real random movement, which more than any other characteristic, distinguishes mechanical toys from the real counterparts they seek to imitate.

In another U.S. Pat. No. 5,344,357 a more sophisticated attempt is made at achieving realism in a swimming fish toy, but its shortcomings make for an item which is far from practical. The need for multiple motors and numerous sensors, along with its rechargeable battery pack, results in a product which is far too expensive to be accepted by the mass market consumer. And when you also consider that the swimming action of this device does not accurately mimic the way that real fish move, we must conclude that U.S. Pat. No. 5,344,357 has not satisfied the need for an affordable swimming fish, which offers children the opportunity to experience the fantasy of playing or swimming with real live fish.

In U.S. Pat. No. 6,179,683 we see an excellent example of an imitation fish, which is not only cost efficient, but very accurate in its representation of the way that real fish swim in the water. This “swimming aquatic creature simulator” as it is called, is hardly a toy however. A long narrow wire protruding from the top of the fish's body presents a serious hazard to children and is difficult to operate. And the requirement for the user to physically provide the power source to make the fish swim, is about as realistic as a toddler's pull toy or a marionette imitating a live human being. One must therefore conclude, that the prior art has offered no practical, affordable, realistic device, which gives children the opportunity to enjoy the playful experience of watching or swimming among fish, that look and behave in a very realistic manner.

### SUMMARY OF THE INVENTION

This invention is concerned with providing a more realistic, battery operated, mechanical swimming fish toy, which provides a more satisfying experience for the user. It is therefore one object of this invention, to provide a more realistic mechanical swimming fish, by constructing an anatomically correct outer body with dramatic detail, decorated with true-to-life colors and features. Such a body must have a hard plastic forward portion, for anchoring the mechanical movements securely, coupled to a semi-flexible rearward portion, which is able to exhibit a realistic motion while swimming in a fluid medium. The area of the fish's body, where the semi-flexible rearward section is joined to the rigid plastic forward section, must be nearly invisible, so as to create the appearance of a seamless outer body without any mechanical hinges or switches.

Another object of this invention, is to provide a battery operated, mechanical, swimming fish, which is simple enough in construction to be more affordable than the prior art, without sacrificing any realism in function to achieve this goal. By controlling the drive motor with timers and other electronic circuitry, it is possible to interrupt the regular back and forth tail motion and more accurately imitate the swimming patterns of real live fish. The drive motor can be reversed intermittently, causing the tail of the fish to operate in only a portion of its full range of motion, resulting in a random left or right turning pattern of movement. This approach provides a very inexpensive way to more accurately simulate the swimming pattern of real fish, which seldom swim in strait lines.

It is a further object of this invention, to provide a mechanical swimming fish, which appears to move in a more lifelike manner within a fluid medium. By incorporating an internal drive paddle, which is detached from the outer, semi-flexible, rearward body, a very realistic motion occurs during use, because the movement of internally hinged components is distributed over a much larger area of outer skin. And because the internal drive paddle is located forward of the tail portion, where the muscle in live fish is actually found, the propelling forces are applied in a way that more realistically mimics what is found in nature.

Another object of this invention, is to provide a mechanical swimming fish, which incorporates a simpler, more cost efficient way for it to respond to changes in the surrounding fluid medium. By employing the use of a simple, internal, mechanical, motion switch, additional voltage can be delivered to the drive motor. Such functionality causes the mechanical fish to swim more quickly if a child attempts to grab or chase after it in the water, thereby simulating the response that a live fish would display in a threatening situation.

Other objects and advantages of this invention, will become apparent, from a consideration of the drawings and ensuing description.

### BRIEF DESCRIPTION OF DRAWINGS

FIG. 1 is a diagrammatic side view of the invention.

FIG. 2 is a diagrammatic top view, illustrating the drive train.

FIG. 3 is a diagrammatic top view, illustrating the drive paddle movement.

FIG. 4 is a diagrammatic top view illustrating how the fish body movement corresponds with the movement of the drive paddle.

FIG. 5 is a block diagram of the electrical system.

### DETAILED DESCRIPTION

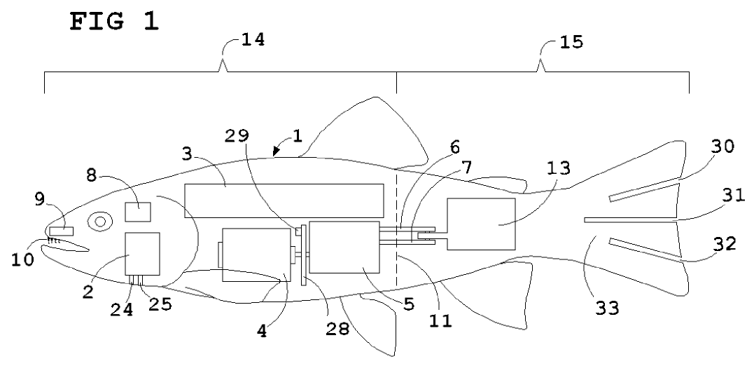

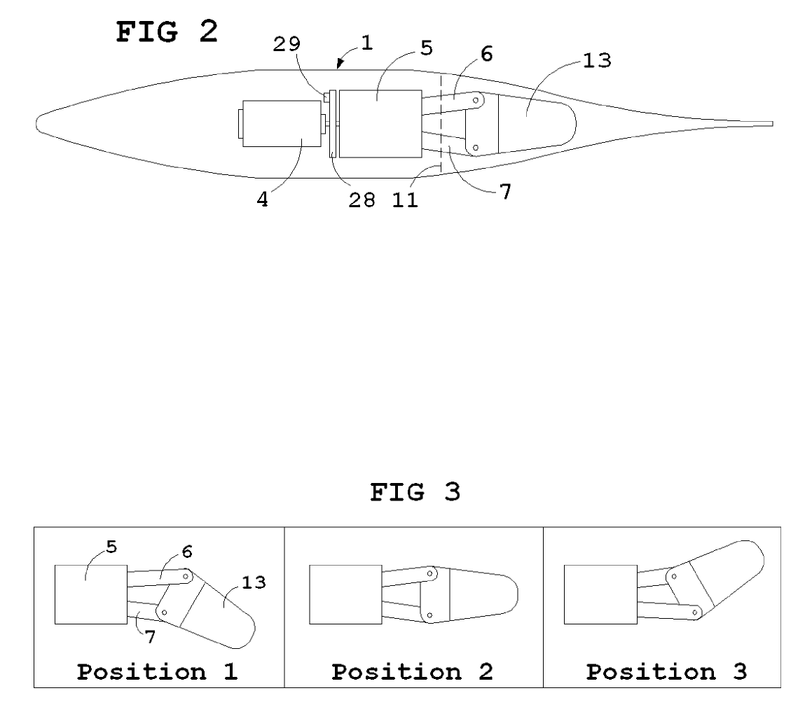

In the preferred embodiment, FIG. 1 discloses a side view of the invention, in the form of a mechanical swimming fish 1. Broken line 11, represents the boundary between a rigid plastic forward body portion 14, and a soft, semi-flexible plastic rearward body portion 15; also illustrated in FIG. 4 where region 14 is proportionally the rigid forward body and region 15 is proportionally the semi-flexible rearward body. A variety of combinations of rigid and semi-flexible plastic materials can be used to construct the outer body of fish 1, so long as a water tight joint between the two materials can be achieved. Preferable, the joint is glued together, so as to create a seamless appearance.

Fish 1 utilizes 6 AAA alkaline batteries within housing 3, which can easily be made replaceable, by incorporating any of several common designs for an access door on the surface of rigid plastic forward portion 14 of fish 1. Such an access door is well understood by those skilled in the art of plastics manufacturing, and should be shaped and positioned in a way that blends in with the exterior detail of the particular fish being imitated.

A Mabuchi 280 series motor 4, provides the necessary torque for excellent performance. Gearbox 5 can be of a number of common designs, but should preferably step down motor 4 by forty to fifty times. Two crank arms 6 and 7 attach to paddle 13 and operate in alternating fashion, as illustrated in FIG. 3. Paddle 13 is not attached to the semi-flexible plastic rearward outer body 15 of fish 1 and as a result is free to move relative to the semi-flexible plastic material during operation. This free floating mechanism is critical and greatly minimizes any wrinkling that would otherwise occur at the sides of semi-flexible body portion 15, if paddle 13 were internally hinged at a fixed position. Slots 30, 31, and 32, allow a small amount of fluid to pass through tail 33, of rearward outer body 15 and thereby reduce or eliminate any suction created on the leeward, or low pressure, side of tail 33 as fish 1 swims in a fluid medium.

Another important point to note about the free floating aspect of paddle 13, is that its ability to distribute the force it imparts on the semi-flexible portion of fish 1 when in motion, creates the familiar undulating, snake-like motion in the body of fish 1, which is displayed by all live fish as they swim about in the water. FIGS. 3 and 4 taken together, clearly illustrate how fish 1 is able to imitate the realistic swimming action of live fish. When paddle 13 is in position 1 as shown in FIG. 3, it applies a force to fish 1 in direction 16 as shown in position 1 of FIG. 4, and because every action causes an equal and opposite reaction, the front end of fish 1 moves in direction 17. Position 2 in both FIGS. 3 and 4 is neutral and position 3 in FIGS. 3 and 4 illustrates the other extreme in the range of motion of paddle 13, with the semi-flexible rear body of fish 1 moving in direction 18 while the front end of fish 1 simultaneously moves in direction 19.

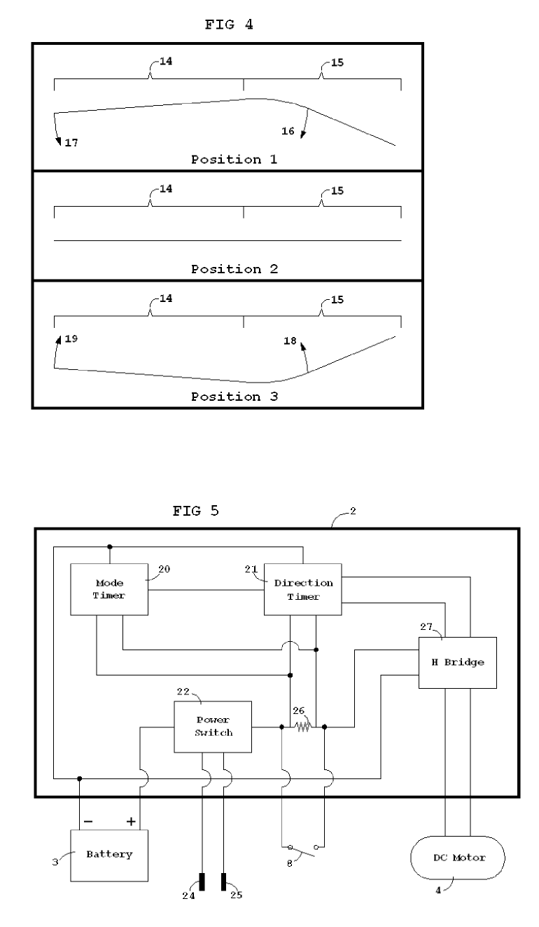

A mechanical, motion activated switch 8, shown in FIG. 1, is incorporated into the invention for the purpose of making fish 1 behave in a more life-like manner. If, for example, a child were to chase after fish 1 as it swam about in a swimming pool, the disturbance in the water would activate motion switch 8 causing fish 1 to swim more quickly, mimicking exactly the response of live fish. This functionality will be explained in detail as part of the description of FIG. 5. Embedded controller 2 is activated automatically when fish 1 enters the water of a swimming pool, a pond, or the ocean, because of a flow of current that takes place between contact posts 24 and 25. Any naturally occurring water source, including common tap water, contains enough impurities to produce positively and negatively charged ions, sufficient to facilitate the required flow of current.

A neodymium rare earth magnet 9, is located above small teeth 10 in the mouth of fish 1, to facilitate a fishing game that could be played with this invention. A steel or magnetic hook, of various designs, could be suspended on a string, using a common fishing pole, to attempt to catch fish 1. Teeth 10 provide additional anchor points to assist in holding on to a hook type device, which has attached itself to magnet 10. Once again, fish 1 would respond in a realistic manner, since an attempt to raise fish 1 up out of the water, would activate motion switch 8 causing fish 1 to flip its tail violently and possible break away. A cam 28 with an off-center mass 29, creates an oscillation in the body of fish 1 to further enhance the realistic response.

Referring now to FIG. 5, a diagram of embedded controller 2 is illustrated along with other components, which together compose the electrical system of the invention. Two timers are incorporated to provide fish 1 with a realistic functionality, that imitates how live fish react in a number of situations. Mode timer 20, maintains a full range of motion in the drive train, so that fish 1 swims in a strait line for about a three second time period. At the end of three seconds, mode timer 20 initializes direction timer 21, which, together with H-bridge 27, causes fish 1 to turn for a two second time period. Turning of fish 1 is accomplished by a signal from direction timer 21, to H-bridge 27, which intermittently reverses the polarity to motor 4, so that drive paddle 13 operates in only one third to one half of its total range of motion. Because no synchronization exists between controller 2 and motor 4, the position of paddle 13 cannot be predicted when direction timer 21 initiates a two second time period for turning. This results in a truly random pattern of swimming displayed by fish 1, sometimes turning to the right and other times turning to the left, and to varying degrees each cycle. The other functionality of controller 2, is to increase the speed of motor 4 when fish 1 is disturbed. This is accomplished by short circuiting a resistor 26, and delivering a higher voltage to motor 4, when motion switch 8 is activated. In the preferred embodiment, battery case 3 contains six AAA size batteries. Resistor 26 allows only half of the total available voltage to reach motor 4, as long as motion switch 8 remains open. When activated, motion switch 8 short circuits resistor 26 allowing the full nine volts of power to reach motor 4.

A latitude of modification, change, and substitution is intended in the foregoing disclosure, and in some instances, some features of the invention will be employed without a corresponding use of other features. Accordingly, it is appropriate that the appended claims be construed broadly, and in a manner consistent with the spirit and scope of the invention herein.

What is claimed is:

1. A swimming fish toy, comprising:
an outer body, said body comprising a rigid forward portion joined to a semi-flexible rearward portion, a magnet and teeth near an open mouth in said rigid forward portion, a DC electric motor and speed reduction gear assembly, a motion activated switch, said switch capable of increasing voltage to said DC electric motor in response to said toy being oriented, such that a central axis connecting said forward portion to said rearward portion, is horizontally non-planar or rotated coaxially, a mechanical means attached to said gear assembly capable of imparting cyclic periodic force to said semi-flexible rearward portion while remaining unattached to said rearward portion, an onboard battery supply, an embedded electronic controller, said electronic controller capable of altering a swimming direction of said swimming fish toy by intermittently reversing polarity to said DC electric motor, said swimming fish toy capable of swimming in a truly random pattern within a fluid medium, independent of any external influence.

2. A toy according to claim 1 in which said electronic controller comprises two electronic timers, an H-bridge, an electronic power switch and a resistor, said electronic power switch electrically connected to two posts, said posts passing outside of said outer body, capable of completing an electrical circuit thereby switching said electronic power switch, said electronic controller electrically connected to a battery supply, said electronic controller electrically connected to said DC electric motor, said electronic controller electrically connected to said motion activated switch.

3. A toy according to claim 1, wherein an off center weight attached to a cam or gear within said mechanical means, creates an oscillating motion within said toy, when a speed of said DC electric motor is increased by said motion activated switch when said switch increases voltage to said motor.

4. A toy according to claim 1, wherein said semi-flexible rearward portion contains at least one slot, through which a fluid medium can pass.
